(19) United States
(12) Patent Application Publication
(10) Pub. No.: US 2015/0248679 A1
(43) Pub. Date: Sep. 3, 2015

(54) PULSE-WIDTH MODULATED REPRESENTATION OF THE EFFECT OF SOCIAL PARAMETERS UPON RESOURCE CRITICALITY

(71) Applicant: International Business Machines Corporation, Armonk, NY (US)

(72) Inventors: Souri Subudhi, Bangalore (IN); Padmanaban Sukhumaran, Bangalore (IN)

(73) Assignee: International Business Machines Corporation, Armonk, NY (US)

(21) Appl. No.: 14/192,943

(22) Filed: Feb. 28, 2014

(51) Int. Cl. G06Q 30/02; G06Q 50/00

(52) U.S. Cl. CPC G06Q 30/0202; G06Q 50/01

(57) ABSTRACT

A method and associated systems for predicting when a resource will become critical to a business. A processor of a computer system identifies a resource as being capable of becoming critical to a business by identifying a historic impact of the resource as a function of prior incidents during which a disruption of the resource had resulted in a severe impact upon the business. The processor further identifies performance parameters and social parameters that were related to these prior periods of criticality and uses these parameters, along with real-time measurements of the performance parameters, to derive a performance index and a social business index that allow the processor to determine whether the resource will become critical during a current or future time period. The processor represents this current or future period of criticality as a pulse-width modulated waveform that may be further processed by automated means.

### TECHNICAL FIELD

The present invention relates to using pulse-width modulation to represent likelihoods of future criticality of a resource.

### BACKGROUND

Methods of forecasting when a business resource is likely to enter a critical state do not adequately consider the effect that social factors have in the past had on that resource's performance and availability.

### BRIEF SUMMARY

A first embodiment of the present invention provides a method for predicting criticality of a resource of a business, the method comprising:

a processor of a computer system identifying a set of resources, wherein a first resource of the set of resources may become critical to a business function during a first current time period, and wherein the first resource is considered critical during the first current time period if a disruption to the resource during the first current time period creates a severe impact upon the business function;

the processor analyzing a historical record, wherein the analyzing identifies a first severe impact upon the business function caused by a disruption of the first resource during a first historical time period, wherein the analyzing further identifies a social-parameter relationship between the first resource and a first social parameter of a set of social parameters, and wherein the analyzing further identifies a performance-parameter relationship between the first resource and a set of performance parameters;

the processor deriving a social business index value as a function of the social-parameter relationship;

the processor measuring a set of current performance values of the set of performance parameters during the first current time period;

the processor further deriving a performance index value as a function of the performance-parameter relationship and of the current performance values; and

the processor determining whether the first resource is critical during the first current time period as a criticality function of the first severe impact, of the social business index value, and of the performance index value.

A second embodiment of the present invention provides a computer program product, comprising a computer-readable hardware storage device having a computer-readable program code stored therein, said program code configured to be executed by a processor of a computer system to implement a method for predicting criticality of a resource of a business, the method comprising:

the processor identifying a set of resources, wherein a first resource of the set of resources may become critical to a business function during a first current time period, and wherein the first resource is considered critical during the first current time period if a disruption to the resource during the first current time period creates a severe impact upon the business function;

the processor analyzing a historical record, wherein the analyzing identifies a first severe impact upon the business function caused by a disruption of the first resource during a first historical time period, wherein the analyzing further identifies a social-parameter relationship between the first resource and a first social parameter of a set of social parameters, and wherein the analyzing further identifies a performance-parameter relationship between the first resource and a set of performance parameters;

the processor deriving a social business index value as a function of the social-parameter relationship;

the processor measuring a set of current performance values of the set of performance parameters during the first current time period;

the processor further deriving a performance index value as a function of the performance-parameter relationship and of the current performance values; and

the processor determining whether the first resource is critical during the first current time period as a criticality function of the first severe impact, of the social business index value, and of the performance index value.

A third embodiment of the present invention provides a computer system comprising a processor, a memory coupled to said processor, and a computer-readable hardware storage device coupled to said processor, said storage device containing program code configured to be run by said processor via the memory to implement a method for predicting criticality of a resource of a business, the method comprising:

the processor identifying a set of resources, wherein a first resource of the set of resources may become critical to a business function during a first current time period, and wherein the first resource is considered critical during the first current time period if a disruption to the resource during the first current time period creates a severe impact upon the business function;

the processor analyzing a historical record, wherein the analyzing identifies a first severe impact upon the business function caused by a disruption of the first resource during a first historical time period, wherein the analyzing further identifies a social-parameter relationship between the first resource and a first social parameter of a set of social parameters, and wherein the analyzing further identifies a performance-parameter relationship between the first resource and a set of performance parameters;

the processor deriving a social business index value as a function of the social-parameter relationship;

the processor measuring a set of current performance values of the set of performance parameters during the first current time period;

the processor further deriving a performance index value as a function of the performance-parameter relationship and of the current performance values; and

the processor determining whether the first resource is critical during the first current time period as a criticality function of the first severe impact, of the social business index value, and of the performance index value.

### BRIEF DESCRIPTION OF THE DRAWINGS

FIG. 1 shows the structure of a computer system and computer program code that may be used to implement a method for a pulse-width modulated representation of resource criticality in accordance with embodiments of the present invention.

FIG. 2 is a flow chart that illustrates steps of a method for predicting criticality of a resource of a business in accordance with embodiments of the present invention.

### DETAILED DESCRIPTION

A business-planning methodology may identify when a resource becomes “critical” to a business's operation or to the business's ability to attain a goal. Embodiments of the present invention comprise a novel method that predicts when a resource may in the future become critical to a business. This novel method comprises a use of criteria inferred from historical data and from other types of business knowledge.

In a relatively simple, clearly bounded system, such as a standalone engineering project, project-management methods known to those skilled in the art may define a “critical path” that comprises a set of “critical” tasks. In such a context, a task is deemed to be critical if delaying completion of the task would delay completion of the overall project.

But in more complex or more dynamic systems or in cases wherein there exists greater coupling among resources, tasks, or other components of a business operation, criticality may be a more complex or nuanced concept. Embodiments of this invention, for example, may identify a business resource as “critical” when one type of disruption to the resource would result in a second type of disruption to a business goal.

An inventory-management software application, for example, might be considered a critical resource if unavailability of the application for a period of time would result in the business's inability to meet its shipping budget. In some cases, a resource may become critical for only a certain period of time. In the preceding case, for example, the inventory-management software might be critical only on those days of the month during which items stored in a central warehouse are inventoried.

As will be described below, embodiments of this invention allow a business to choose a business-specific meaning to a determination of criticality that allows the business to identify those times when a business goal will become dependent in some way upon a characteristic of a resource. A resource might, for example, be deemed “critical”: when a failure of the resource or a delay to a task that depends upon the resource would have any adverse impact on a business goal; when a failure of the resource a delay to a task that depends upon the resource would have an adverse impact upon a business goal that exceeds a threshold level of impact; or when a failure of the resource or a delay to a task that depends upon the resource would have an adverse impact on a business goal, where that impact is significantly greater than the impact would be under normal conditions.

In some cases, a criticality of a task or of a resource during a period of time may be conditional, depending on an occurrence of a certain combination or sequence of events, or upon a determination of whether other resources associated with such a combination or sequence are themselves critical. Many other criticality criteria are possible, and may be selected by those skilled in the art who have knowledge of a business's goals, operations, or other characteristics, such that the resulting definition of criticality measures a parameter from which may be inferred a characteristic of a business's ability to meet its goals.

Identifying a period of criticality of a resource may be a function of factors that are related to specific types of business knowledge, such as characteristics of business functions, characteristics of the resource, characteristics of other business resources, or characteristics of an environment in which the business operates.

Such factors may, for example, be associated with past, present, and projected performance or availability of a specific resource, or with an extrinsic or social factor that characterizes a client, an industry, a system, or an environment within which a client, industry, or system exists.

Embodiments of the present invention thus describe a framework method for forecasting when a resource may become critical by using historical records and other types of business knowledge to identify and quantify performance factors and social factors. This method then encodes the resulting criticality projections as a pulse-width modulated data stream, or a “client pulse.” This encoding allows those skilled in the art to extract, further process, or analyze the encoded criticality information by means of known techniques of pulse-width demodulation.

Embodiments of the present invention may be implemented as a method performed by a processor of a computer system, as a computer program product, as a computer system, or as a processor-performed process or service for supporting computer infrastructure.

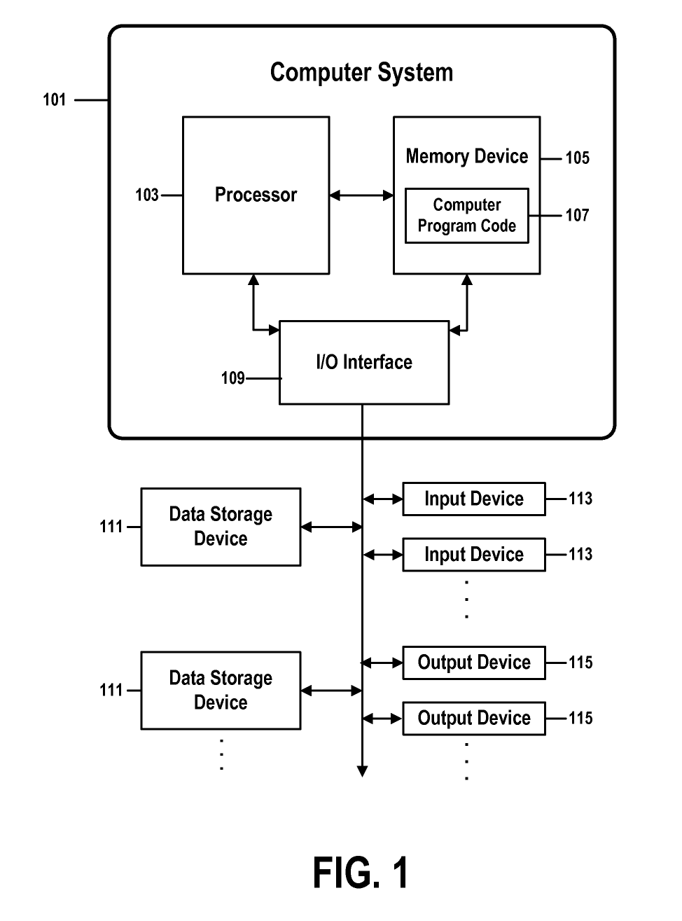

FIG. 1 shows a structure of a computer system and computer program code that may be used to implement a method for predicting criticality of a resource of a business in accordance with embodiments of the present invention. FIG. 1 refers to objects 101-115.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for pulse-width modulated representation of the effect of social parameters upon resource criticality in accordance with embodiments of the present invention, and may implement other embodiments described in this specification, including the methods illustrated in FIGS. 1-3. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for pulse-width modulated representation of the effect of social parameters upon resource criticality.

Any of the components of the present invention could be created, integrated, hosted, maintained, deployed, managed, serviced, supported, etc. by a service provider who offers to facilitate a method for pulse-width modulated representation of the effect of social parameters upon resource criticality. Thus the present invention discloses a process for deploying or integrating computing infrastructure, comprising integrating computer-readable code into the computer system 101, wherein the code in combination with the computer system 101 is capable of performing a method for pulse-width modulated representation of the effect of social parameters upon resource criticality.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

While it is understood that program code 107 for r predicting criticality of a resource of a business may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for r predicting criticality of a resource of a business is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

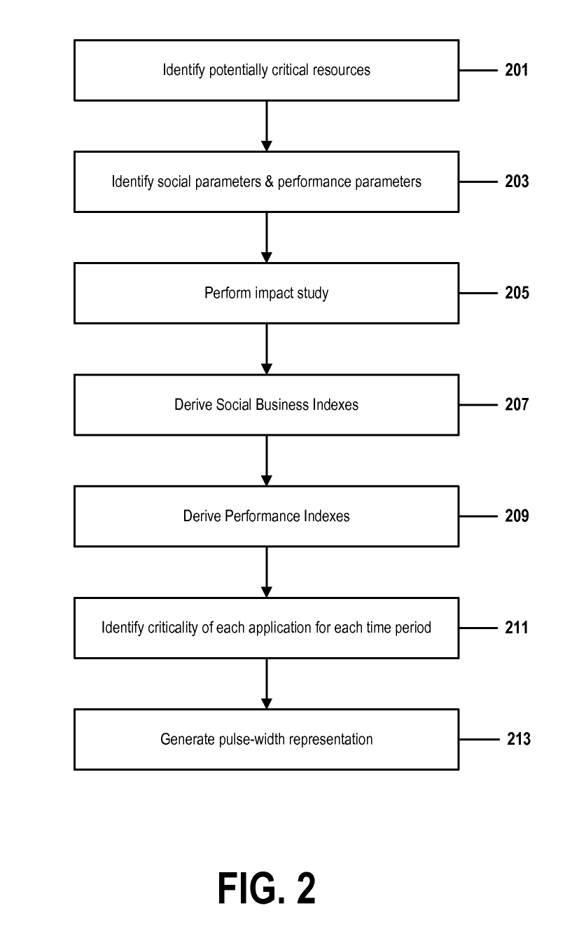

FIG. 2 is a flow chart that illustrates steps of a method for predicting criticality of a resource of a business in accordance with embodiments of the present invention. FIG. 2 comprises steps 201-213.

In step 201, a processor of a computer system or a business analyst analyzes historical records of business activities and of resources used in those activities to identify resources that had in the past become critical to the business at certain times and that may thus become critical to the business in the future.

These historical records may be identified, aggregated, collected, stored, organized, or analyzed by any means known to those skilled in the art. They might comprise, for example, combinations of software-application log entries, maintenance records, performance records, extrinsic information (such as holiday calendars or usage records of affiliated businesses), or user incident-report logs, or other types of records.

Such historical records might, for example, identify that a report-generating software application requires greater system resources on the 21^{st} and 22^{nd} day of every month, when the business's largest client issues its monthly sales report. In another example, historical records might comprise information that, during the first week of May of the two most recent years, a Human Resource Department server temporarily ran out of disk space, and that this event resulted in a disruption of essential Human Resource Department functions for four days. In yet another example, a historical record might indicate that, when a hardware failure resulted in the Finance Department's main server becoming unavailable for three days in January of the current year, year-end closing statements were delayed by two weeks.

In embodiments described herein, historical records may be analyzed to identify or characterize past incidents that produced an impact on a business function, wherein that impact might be characterized as having been “severe.”

These and other types of historical data may be used in step 201 to identify resources that might become critical to the business in the future and to identify when such criticality might occur. In one of many possible examples, such an identification might in part comprise: i) enumerating all software applications used by the business over a prior 48-month period; ii) associating each enumerated application with a server that hosts the enumerated application or that hosts a database used by the enumerated application; iii) identifying a performance parameter associated with each associated application, server, or database, where each performance parameter comprises a measure of weekly usage levels over the last 48 months of an enumerated application or of a server or database associated with an enumerated application; and iv) identifying a subset of the associated applications that became critical during a period of time (that is, that, by its failure, had a severe impact on a business operation) if any of the applications, databases, or servers associated with the subset satisfied a criticality requirement during that period of time.

Many other sequences of steps may allow a method of FIG. 2 to use historical records to identify potentially critical resources. A choice of these steps may be a function of a nature of a resource, a content of a set of historical records, a goal of the business, or a combination of other embodiment-specific or business-specific factors. In all cases, information contained in or related to the historical records may be used as a means of identifying resources that may become critical in the future.

Examples of information that might be used to identify when a resource is in a critical state might comprise, but are not limited to, identifying that a resource becomes critical to a business (that is, identifying that a disruption to the resource would have a certain degree of impact or a certain type of impact on a business function): when an upgrade or patch-installation is performed on the resource that is an application, database, or server operating software or hardware; when a number of concurrent users of a resource exceeds a certain value for a certain duration of time; or when demand on an resource that is application, database, or server increases by an amount that exceeds a certain value, such as when demand for an accounting application increases during a year-end closeout or demand for a transaction-processing application increases when a sales force uploads its end-of-day daily reports. Many other criticality criteria and conditions are possible, based on the embodiment's application-specific or business-specific requirements, or upon other factors that may be identified by persons possessing knowledge of business's operations, goals, resources, clients, or other relevant characteristics.

Resources that satisfy a combination of such criteria may be deemed in step 201 to have been critical during a historical period in which they satisfied such criteria and may thus be identified as being capable of becoming critical in the future. Resources identified by such means will be further evaluated by further steps of the method of FIG. 2.

In step 203, a processor of a computer system, or a designer or analyst with expert knowledge of the business, identifies a set of performance parameters and a set of social parameters related to the resources identified in step 201. As in step 201, these parameters may be identified by analyzing historical records. Parameters may also be identified by other means known to those skilled in the art, such as by means of expert knowledge of the operations, resources, goals, corporate culture, market, product lines, or other characteristics of the business.

Here, performance parameters of a resource may comprise, but are not limited to, combinations of: an availability or capacity-utilization of the resource; other utilization statistics; resource response times; resource failure rates; fluctuations in a number of concurrent users of a resource; or other parameters related to the past, present, and expected performance of hardware, software, communications, financial, human, or other resources that might be identified as being critical to the business, or that might be identified as being associated with an other critical resource of the business.

A performance parameter might, for example, be a measure of unused storage capacity of a mission-critical array of network-attached storage devices; a per cent of CPU-utilization or memory-utilization of a server; or an average number of streaming-video requests received by a router at a certain time of day.

In some embodiments, performance parameters might be identified as a function of logged user usage patterns, wherein usage patterns might be a function of, or a proxy for, an indication of a load on a resource. In one example, even if a business has no way to measure historical patterns of a server's memory utilization, it may be able to infer that such utilization is in general proportional to a parameter that has been recorded, such as a number of concurrent users of the server.

Many other types of methods may be used to identify performance parameters, and these methods may relate states, conditions, or values associated with a performance parameter with a greater or lesser risk of an occurrence of an incident, or of an occurrence of a severe incident.

Resources identified in step 201 may have a many-to-many relationship with performance parameters identified in step 203. That is, a resource may depend upon more than one of the performance parameters and more than one resources may depend upon one performance parameter.

Here, social parameters may comprise, but are not limited to, factors associated with: market demand for the business's products or services; or characteristics of an industry, market, or other environment in which the business operates. A social parameter may, for example, be a seasonal fluctuation in demand for gift items during a holiday sales season, or for summer wear at the beginning of summer.

Many other types of performance parameters and social parameters may be identified, as functions of factors related to resources, business goals, characteristics of business operations, or other implementation-dependent or business-dependent details known to designers who have knowledge of the business.

Resources identified in step 201 may have a many-to-many relationship with social parameters identified in step 203. That is, a resource may depend upon more than one of the social parameters and more than one resources may depend upon one social parameter.

At the conclusion of step 203, methods of the present invention described in FIG. 2 will have identified a list of resources that have the potential to become critical to the business during a future time span that is being evaluated by the methods, and will have further identified sets of performance parameters and social parameters that may determine all or in part when a resource of the list of resources may become critical in the future.

In step 205, a processor or analyst may perform an impact study that identifies an amount of impact upon the business, or upon a client of the business, that may result from a disruption to a resource identified in step 201. An ultimate goal of the impact study is to relate a disruption of a resource identified in step 201 to a resulting severe incident, to one or more social parameters, or to one or more performance parameters. The impact study may further relate this impact to a characteristic of one or more performance parameters or social parameters identified in step 203.

The impact study may further identify for each severe incident, or for each identified resource, a future risk of a similar incident occurring (a “predicted business impact”), or factors that may in the future revise the predicted impact upward or downward (a “planned risk revision”). A planned risk revision may comprise entities like a mitigation plan that may reduce future impact risk (such as a planned replacement of aging resource hardware) or that may increase future impact risk (such as a departmental move to a new geographical location).

In some embodiments, this impact study is performed all or in part by automated means that identify and relate elements of information comprised by the historical data or that is culled from extrinsic sources.

In some embodiments, this study may further associate a performance parameter or a social parameter identified in step 203 with a distinct impact value upon the business, upon an entity related to the business, or upon a resource of the business of or an entity related to the business.

In some embodiments, the impact study will identify a historic impact value with each resource identified in step 201, wherein a historic impact may comprise a logical value, capable of assuming only either a TRUE value or a FALSE value, and of indicating whether a characteristic or conditions of an associated performance parameter or social parameter satisfies one or more criteria specific to the embodiment or to the needs of the business.

In other embodiments, an impact value may be a numeric or quantitative entity that is associated with a degree of impact or with an otherwise quantifiable amount of impact. That numeric or quantitative entity may in some embodiments be expressed as a decimal number within the range of 0.0 through 1.0. In other embodiments, other types of numeric or logical representations may be selected as a function of a specific business requirement or characteristic.

This relating or other association of an impact value with a characteristic of one or more performance parameters or social parameters, with a degree of severity of an impact of a prior incident upon a business function, and with a resource identified in step 201, may be performed all or in part as a function of information extracted from the historic records.

Such a function may comprise identifying values of or changes the characteristic during a time associated with a resource disruption. In some embodiments, this function may comprise correlating a state of the one or more parameters with a disruption or other incident and with a type and amount of impact to the business that resulted from the disruption or other incident. If the impact satisfies a criticality condition, such as exceeding a threshold level of severity of impact on the business or a threshold duration of impact on the business, then the disruption may be deemed to be a disruption of a critical resource and the resource may be deemed as having been critical during a time period associated with the disruption.

In one example, an impact study might reveal a correlation between a disruption of a resource and a resulting severe impact upon a business operation, wherein the impact is associated with an seasonal increase in market demand. Such a correlation might reveal an “historic impact” from which may be inferred a 70% “predicted risk impact” that a Sales Department software application will become critical during a retail outlet's end-of-summer close-out promotion. The impact study might further reveal a “planned risk revision,” based on a designer's expert knowledge of the business, or upon an automated means, wherein the planned risk revision would comprise a scheduled component-replacement expected to reduce the risk of impact from 70% to 10%.

In this example, an impact study may in step 205, by analysis of events concurrent with a repetitive seasonal occurrence of the promotion, correlate an occurrence of an end-of-summer seasonal period (identified as a social parameter in step 203) with a negative impact on the business. By implication, this conclusion would further imply that a software application resource (identified in step 201 as a potentially critical resource) becomes critical during this period. In this manner, the impact study would thus identify or quantify an impact on the business of a disruption of the software application during this time period and would use this information to infer a future predicted risk impact and a future planned risk revision for this application resource.

In another example, historical records or an inference associated with a result of an impact study may have revealed in step 203 that a business's accounting program identified in step 201 has consistently become critical at the end of each fiscal year because, during that period, every disruption in the accounting program's availability results in a severe impact to a business operation by delaying completion of an important accounting function. The impact study may then further infer from this historic impact a correlation between the accounting-program resource and the end-of-fiscal-year social parameter because the business closes large numbers of accounts at the end of each fiscal year, thus creating greater-than-usual demand upon the program. Based on these observations, the impact study might then identify a predicted risk impact on the business, as a function of a delay to the accounting function, caused by any disruption of the accounting-program resource during the end of the fiscal year—a time period during which the program will become a critical resource. Here, no planned risk revision is identified.

In yet other examples, an impact study may determine: that a financial application becomes a critical resource when it is used to model and generate the business's financial statements and annual report and that disruptions to this resource during this critical period may have a certain impact on the business; that an e-commerce application becomes critical during the final three weeks of each year's holiday shopping season and that a disruption to this application during this critical period may have a certain impact on the business; or that any program of a cluster of software programs that are normally run at least weekly is 85% likely to become critical from a time period that extends from 14 days prior to an upgrade through the 7 days after the upgrade is completed, and that a disruption to such a program during that time frame thus has a corresponding 85% chance of having a particular amount of impact on any of several business functions.

In some embodiments, an impact study may identify or infer other types of correlations related to a performance parameter or social parameter that is associated with a characteristic of an industry, market, or other environment. Examples of such correlations comprise: during each holiday sales season, all online retail-sales applications in every retail sector of the business's secondary market become critical, resulting in an impact on the business when one of those applications is disrupted; during July and August, all ticketing applications associated with concert-ticket sales in the business's geographic market become critical, resulting in an impact on the business when one of those ticketing applications is disrupted; the business's primary Web servers become critical resources for 72 hours after identification of any new strain of malware that affects a Web-development application or a database-management system installed on the servers, resulting in an impact on the business's Web operations if a suspicious server activity forces administrators to run a memory-intensive malware scan on the servers during that period; or a shipping resource used by a business's automotive plant becomes critical for 90 days following an industry prediction of a next-quarter increase in midsized car sales because disruption to the shipping resource adversely may affect a business's accelerated shipping schedule during that time.

Some embodiments may further identify a historic impact on an operation, resource, or other characteristic of a client, colleague, affiliate, or customer of a business. Consider, for example, a case in which a state of a social parameter correlates with a likelihood that a disruption to a warehousing application will delay a shipment of wholesale goods. Even if such a delay has no impact on the day-to-day operation of the business, the software application may still be considered to be in a critical state at the time of the disruption if a resulting delay has a severe impact on a retailer that purchases goods from the business.

In some embodiments, an impact study may in step 205 attempt to quantize a degree of an impact or a degree of criticality of a resource based on a severity or on a duration of the impact resulting from a disruption of the resource. In other embodiments, the impact study may merely identify that an identifiable severe impact may occur, where an identifiable severe impact may be an impact that satisfies one or more threshold conditions of severity, such as causing a financial loss in excess of a certain dollar amount.

In some embodiments, a result of an impact study may be used to determine a granularity of a time scale of an output pulse-width modulated representation of resource criticality. This determining may be made as a function of a duration of a resource's state of criticality or noncriticality, or a frequency at which a resource becomes critical or noncritical.

If, for example, an impact study, or other information derived in steps 201-205, reveals that a resource on average becomes critical at most four times a year and on average remains critical for 4-6 days, then a corresponding output pulse-width modulated representation of criticality of the resource might indicate criticality in units of weeks. Expending resources to forecast periods of criticality in finer units, such as hours, or minutes, might here be considered unnecessary.

In another example, if an impact study of historical records reveals that a resource may become critical on any day of the year, but may remain critical for at most for 16 hours, a pulse-width modulated representation may need to represent criticality in units of days. In yet another example, if resources have historically become critical during only a few crucial months of the year, but typically remain critical for 3-4 weeks at a time, then a monthly resolution may be appropriate or most efficient. In some cases, limitations in a precision, completeness, or accuracy of historical data may further influence a granularity of a pulse-width modulated representation of criticality generated in step 213.

In step 207, the processor computes a set of “social business indexes” as a function of information extracted from or inferred from historical records in steps 201-205. In some embodiments, a distinct social business index may be computed for each resource identified in step 201, and for each time period during the time span being forecasted by the pulse-width modulated representation generated in steps 211-213.

In some embodiments, a social business index may be represented as a positive decimal number within a range from 0.0 through 1.0, where a value of 0.0 indicates that variations in the value or state of the social parameter have no impact on the business and a value of 1.0 indicates a maximum amount of impact.

In other embodiments, a social business index may be represented as a logical entity that may be represented as a “high” or “low” value, a TRUE or FALSE value, or as a 1 or a 0 value.

A social business index (SBI) of a resource identified in step 201 during a time period may be derived as a function of the form:

SBI=(historic impact)+(planned risk revision)+(predicted business impact)

Here, “historic impact” refers to an impact upon a business function caused by a disruption of the resource. This value may be derived as a function of the impact study or of an other analysis of historical records or of other information available to one possessed of expert knowledge of the business. As noted above, exact values, scale, range, and data-type of this term are implementation-dependent and may be determined by analytical methods known to those skilled in the art.

In some embodiments, other factors, risk adjustments, or impact adjustments may be considered in a derivation of an SBI. Such other terms may be implementation-dependent or may be a function of a goal, operational detail, or other characteristic of the business. In some embodiments, one or both of planned risk reduction and predicted business impact terms may be omitted from a derivation of an SBI, or one or both of those terms may be null or may have a zero value or an other value that does not alter a value of an SBI that is derived from them.

In embodiments, this term may be represented as a value that increases monotonically as a function of a degree of impact of the disruption upon the business. If, for example, a disruption to a first resource has in the past produced a loss of hundreds of dollars to a business, but a disruption to a second resource has in the past produced a loss of thousands of dollars, then the historic impact of the first resource will be less than the historic impact of the second resource.

As discussed in the description of the impact study of step 205, a “planned risk revision” is an adjustment to the value of the historic impact, where the adjustment is a result of a planned or known occurrence that will reduce or increase the risk of or degree of impact associated with the resource during the time period.

In one example, a disruption of a first resource may have historically had a severe impact on a business because the disruption reduced the business's ability to ship adequate volumes of a key product line. But if that key product line will be discontinued in six months, an impact of such a parameter may no longer be as important to the business during time periods that are at least six months in the future. This impact reduction, would not, however, be identifiable by analyzing historical data. In such a case, this negative planned risk revision factor would reduce or negate the historic impact of the resource during those future time periods and thus reduce the social business index of this application for those time periods. In some embodiments, if this revision is large enough to completely offset the historic impact term, the resulting reduction might revise an SBI value from a value of 1 or TRUE to a value of 0 or FALSE.

As with the historic impact parameter, the values, scale, range, and data-type of the planned risk revision term are implementation-dependent and may be determined by analytical methods known to those skilled in the art.

The term “predicted business impact” may further adjust the value of the historic impact of the social parameter by adding or subtracting an amount of impact that is identified by a predictive study. In some embodiments, this term may be optional.

A predictive study may be performed by any information-gathering means known to those skilled in the art, such as personal interviews, questionnaires, statistical analyses, or a statistical or other type of forecasting methodology.

In some embodiments, a predicted business impact may be inferred through a straightforward extrapolation of a trend inferred by the impact study of historic records. In other embodiments, a predicted business impact may be inferred by further analysis of other information or by further correlation of historical information and extrinsic data gathered from other sources.

If, for example, a predictive study forecasts increased demand for a product from a specific region, then a positive predicted business impact factor might be added to an SBI that is associated with a business's ability to ship product to that region. Conversely, if a study forecasts decreased demand for a product due to changes in climate or to a social status of a target demographic, a negative predicted business impact might be used to decrease the SBI of a social parameter related to that climate or social status.

In some embodiments, a predicted business impact may be inferred solely from historic data or from the impact study. If, for example, historic data reveals that a customer-service application is more likely to have a severe impact on the business if it becomes unavailable on the last week of every month—regardless of whether a reason for the severity is known—then this knowledge may be used to derive a positive predicted business impact value for an SBI derived for the customer-service application during time periods that span the last week of every month.

As with the historic impact term, the values, scale, range, and data-type of the predicted business impact term are implementation-dependent and may be determined by analytical methods known to those skilled in the art.

An SBI of an application can thus be described as a measure of past impact upon a business of disruptions of the application, adjusted for planned changes that may in the future alter that historic amount of impact, and further adjusted for predicted changes in social parameters that may in the future further alter than impact.

An SBI derived in this way may be represented by means of any value, scale, range, function, or data type determined by analytical methods known to those skilled in the art, as necessary to characterize an impact of a social parameter on an operation of the business. In some embodiments, an SBI may be a logical TRUE/FALSE variable. In other embodiments, it may be assigned an integer numeric value, a positive integer numeric value, a negative integer numeric value, an unsigned or absolute numeric value or, or a decimal numeric value. In some embodiments, it may be a numeric value constrained to a specific range, such as a decimal value within a range of −1.0 to +1.0, or a decimal value within a range of 0.00 to 1.00. In embodiments described in examples, herein, a social business index may be represented as a per cent value ranging from 1% to 100%, where a per cent value may be a function of the amount of impact that a disruption of a resource may have upon a business operation, and where the disruption may be a function of values of social parameters.

A precise means of representations of terms of this equation are not tied to embodiments of this invention. What is important here is the qualitative meaning of each term and the dependency of an SBI upon the relationships among the terms. In some embodiments, a planned risk revision term or a predicted business impact term may be omitted or may be optional. In other embodiments, other, similar adjustments may be added to the equation in order to derive an SBI value that more precisely or more accurately models real-world behavior.

In step 209, the processor computes a set of “performance indexes” as a function of information extracted from or inferred from historical records in step 201 or step 203, or extracted from or inferred from a result of an impact study in step 205. One or more distinct performance indexes may be computed for each resource identified in step 201 or for each performance parameter identified in step 203. At least one value of a performance index may be derived for each time period represented by a pulse-width representation of a criticality of a resource generated in steps 211 and 213.

A performance index of a resource characterizes a risk of criticality of a resource identified in step 201, or of severe impact upon an operation of the business or an entity associated with a business, wherein the amount of risk is a function of a change in a performance parameter identified in step 203 that is related to the resource.

While a social business index may be identified by methods known to those skilled in the art, such as methods of business analytics, some performance indexes may be derived through straightforward analysis or processing of automatically or manually generated system logs.

The exact values, scale, range, and data-type of a performance index are implementation-dependent and may be determined by analytical methods known to those skilled in the art. In some embodiments, a performance index may be represented as a value that increases as a monotonic function of a degree of impact of the social parameter.

In some embodiments, a performance index may be derived as an aggregate function of one or more performance parameters identified in step 203 that are associated with an application, service, or other resource identified in step 201. If, for example, an availability or a level of performance of an application may be affected by a server's CPU utilization, by a disk drive's available storage capacity, or by an amount of bandwidth utilization of a network backbone, then a performance index of the application may be considered to be high (and thus suggest a greater likelihood of an impact upon the business resulting from a disruption of the application) when any one or more of those three performance parameters exceeds a threshold value or satisfies an other criticality-related condition.

In some embodiments, a performance index may be represented as a positive decimal number within a range between 0.0 and 1.0, where a lower performance index closer to 0.0 may indicate that a first performance parameter associated with the first index has little effect upon a business or upon an entity associated with the business and where a higher performance index that approaches 1.0 may indicate that a second performance parameter associated with the second index has a greater effect upon a business or upon an entity associated with the business.

In other embodiments not described in FIG. 2, a performance index may assume a value of 0.0 or 1.0, wherein the two boundary values of 0.0 and 1.0 are deemed out of range as extremes that indicate, respectively, that a performance parameter or other measure has either unvarying zero effect on a risk of criticality of a resource, or unvarying constant effect on a risk of criticality of a resource.

In embodiments described in FIG. 2 and in the example below, a performance index may be represented by a positive integer number within a range of 1-4, where a lower integer value represents that a value of a performance parameter during a first time period has increased a risk of a resource associated with that parameter becoming a critical resource during that time period.

Consider, for example, an accounting-program resource identified in step 201, where the accounting-program resource has been associated with two performance parameters identified in step 203. The first performance parameter of the accounting program might be a % of memory utilization of an server that hosts the application, and the second performance parameter might be the server's available hard-drive capacity. In this example, a resulting performance index for a future time period might be a function of values of the two performance parameters during that time period. One such function might, for example, be derived by assigning to each of the two parameter a “severity value” ranging from 1-4, where each severity value is associated with a range of parameter values, and then setting the performance index to the greater of the two severity values.

At the conclusion of step 209, a method of the present invention will have derived a set of performance indexes for each application, service, or other resource identified in step 201, for each time period that will be included in the pulse-width modulated criticality representation generated in steps 211-213.

In step 211, a criticality of each application, service, or other resource identified in step 201 is forecast for each week of the time period to be represented. In some embodiments, this forecasting may be done by any statistical, logical, or mathematical means known to those skilled in the art as a function of entities identified and derived in steps 201-209.

In embodiments described herein, criticality may be represented as a numeric value of 1 or 0 (corresponding to logical values of TRUE or FALSE). In other embodiments, criticality may assume other numeric values between the values of 0 and 1 or may assume other positive or negative numeric values outside the range of 0 to +1. In the embodiment described here, only two levels of criticality are identified—“critical” and “noncritical”—but in other embodiments, criticality may be identified with greater precision by defining more than one possible value of criticality.

Criticality of a resource during a particular time period may be derived as a function of the form:

criticality=(historic impact*SBI)/(performance index)

This formula illustrates a criticality of the application during the time period as a function dependent upon a historic impact of the resource identified by the impact study in step 205, by a social business index associated with the application and with the time period identified in step 207, and by a performance index associated with the application and with the time period identified in step 209.

If the historic impact is greater, for example, indicating a greater risk that the resource will be critical during the time period, then the criticality is more likely to be 1, or “high.” If the social business index is greater during the time period, then the criticality is more likely to be 1, or “high.” Here, because performance index values are arbitrarily defined such that lower performance-index values are associated with a greater risk of an occurrence of a severe incident, if a performance-index value is lower during the time period, then the criticality is more likely to be 1, or “high.”

A greater risk of criticality of the resource during a time period may thus be indicated by this function by a combination of a high degree of historic impact to the business by past disruptions to the resource, a higher-risk value of a social-business index associated with the resource, and a higher-risk value of a performance index during the time period.

These relationships do not prevent the scope of the present invention from including similar functions in which one or more parameters varies in a direction inverse to that described above. In embodiments, for example, where higher performance-index values are associated with a greater risk of an occurrence of a severe incident, a performance-index value might be lower during the time period, then the criticality is more likely to be 1, or “high.”

In a first example, consider the first table below, which illustrates how criticality may be derived for a duration of five time periods. Here, criticality is defined to have a “high,” TRUE, or 1 value if the computed criticality value exceeds an implementation-dependent threshold value of 0.6.

During time period “TIME 1,” for example, the resource in question is associated with a historic impact=0.2 and a social business index of 2.0. During time period “TIME 1,” real-time measurements of performance parameters associated with the resource yield a performance index value of 1. The criticality value for the resource during this time period is thus 0.2*2/1=0.4. Because 0.4 does not exceed the criticality threshold value, the associated pulse value for this time period=0.

| | TIME | TIME | TIME | TIME | TIME |
|---|---|---|---|---|---|
| | 1 | 2 | 3 | 4 | 5 |
| Historic Impact | 0.2 | 0.4 | 0.5 | 0.5 | 0.5 |
| Social Business Index | 2 | 1 | 3 | 4 | 1 |
| Performance Index | 1 | 1 | 1 | 1 | 1 |
| Criticality (HI*SBI/PI) | 0.4 | 0.4 | 1.5 | 2 | 0.5 |
| Pulse (=1 if C > 0.6) | 0 | 0 | 1 | 1 | 0 |

The table below further illustrates an additional set of criticality-derivation examples computed in the same way.

| | TIME | TIME | TIME | TIME | TIME |
|---|---|---|---|---|---|
| | 11 | 12 | 13 | 14 | 15 |
| Historic Impact | 0.2 | 0.4 | 0.5 | 0.5 | 0.5 |
| Social Business Index | 1 | 1 | 1 | 1 | 1 |
| Performance Index | 0.5 | 0.8 | 0.3 | 0.2 | 0.9 |
| Criticality (HI*SBI/PI) | 0.4 | 0.5 | 1.67 | 2.5 | 0.56 |
| Pulse (=1 if C > 0.6) | 0 | 0 | 1 | 1 | 0 |

At the conclusion of step 211, a set of criticality values will have been generated for each resource identified in step 201 for each time period to be represented by the pulse-width modulated waveform generated in step 213.

In step 213, the set of criticality values generated in step 211 are formatted into a user-readable chart, graph, or other display. One axis of this chart, graph, or other display represents times and the other represents criticality values. In some embodiments, the time scale is calibrated in time-period units identified above by steps 201-205.

The criticality of each application will be represented in this way as a series of high and low values, wherein a high value may be interpreted as a pulse. The number of adjacent pulses may describe a pulse-width. If, for example, the time scale is calibrated in units of weeks, a pulse that lasts for three contiguous weeks—representing a three-week period of time during which an application is considered critical—then that pulse may be considered to have a pulse-width of 3. In other embodiments, a pulse-width may be derived as a different function of a number of contiguous or noncontiguous time periods spanned by the pulse. In some embodiments, this pulse width may be identified as a function of the degree of importance, severity, or other characteristic of the period of criticality represented by the pulse. Such pulse-width values may be processed, decoded, or otherwise interpreted by mathematical methods known to those skilled in the art of pulse-width modulation.

Examples of such pulse-width modulated representations are described in the concrete example below.

Steps of the method of FIG. 2 are illustrated in the following concrete example. This example presents one possible embodiment of the method of FIG. 2, as it would be performed in a real-world situation. In this relatively simple, illustrative example, the one possible embodiment identifies critical states of applications upon which one or more operations of an “ABC Company” depend. The example is not intended to limit the scope or application of embodiments of the present invention.

In step 201 of this example, an automated tool or an expert familiar with operations of the ABC Company would identify a set of potentially critical resources. Here, those resources might comprise a set of software applications upon which operations of the ABC Company's business might depend.

In this example, this identifying might begin with a study or other analysis of how past incidents have affected ABC Company's ability to serve its customers. Such analysis could comprise steps that include:
interviewing customers to select applications produce output upon which the customers depend;
identifying incidents that occurred during a recent time period (here, during the last 24 months); and
selecting identified incidents that are judged to be “severe” as a function of selection criteria chosen by means known to those skilled in the art.

The facts surrounding each incident judged to be severe would then be analyzed in order to further identify a relationship between the severe incident and one or more disruptions to one or more of the selected applications. An application that is associated with such a relationship will be considered a potentially critical resource and will be process further by other steps of the method. In other embodiments, such resources may comprise other types of entities, such as hardware devices, communications infrastructure, other hardware or software components, financial entities, human resources, or other resources of a business.

In this example, two of the relationships identified between severe incidents and potentially critical resources comprise:
on January 21 of the prior year, a monthly sales report was delayed by a two-hour period of unavailability of a sales application the same day; and
on March 23 of the same year, a severe incident was caused when a two-hour disruption to a mortgage-processing application, thereby preventing the company from processing new mortgages for four hours.

At the conclusion of step 201, using expert business knowledge of the ABC Company and its customer, and further using analytical techniques known to those skilled in the art, developers are in this example were able to identify five potentially critical applications or services that had been all or partly responsible for severe incidents during the studied time period. These five applications or services comprise:
a sales application,
a human resources application,
a mortgage-processing application,
a call-center voice-support application, and
the www.ABC.com Web site interface.

In step 203 of this example, an automated tool or an expert familiar with operations of the ABC Company would identify a set of social parameters and a set of performance parameters that will be used in later steps to identify critical applications of the ABC Company.

In this example, the social parameters and performance parameters identified in this step fall into several categories described below. In other embodiments, other types of social parameters and performance parameters may be considered or identified, as functions of details of the goals of the embodiment, of the business, or of other implementation-dependent factors.

Here, a first set of social parameters might comprise parameters related to a business demand of ABC Company. Such social parameters may be identified as a function of information provided by ABC, based on ABC's planned schedule of business operations or on ABC's planned schedule of maintenance and upgrade activities associated with potentially critical hardware or software.

In this example, such social parameters might identify the following potentially critical time periods, where those periods are each associated with a maintenance or upgrade operation related to one of the applications identified in step 201:
the sales application undergoes maintenance during the last week of each quarter;
the human resources application undergoes maintenance during the last week of July and during the last week of November;
the mortgage-processing application undergoes maintenance during the second week of August and will be upgraded on or about April 3 of next year;
the call-center voice-support application is disrupted by a general audit during the last week of May and during the last week of November; and
the www.ABC.com Web site interface will undergo a major upgrade during the last week of December of this year.

In this example, a second set of social parameters might further identify the following potentially critical periods, where those periods are each related to a particularly high or low period of market demand associated with one of the applications, services, or severe incidents identified in step 201, or which may otherwise suggest a future occurrence of such a period:
a Federal agency may adjust interest rates during the first week of June and the first week of November of the current year, thereby affecting demand for ABC products that are typically purchased with the help of financing; and
the ABC Company will launch a heavily promoted product line during the first week of July of the current year.

A first set of performance parameters might comprise parameters related to performance of an application or service identified in step 201, or to a capability, capacity, or other performance measurement associated with hardware, software, communications components, or other resources used by an application or service identified in step 201. In this example, this first set of performance parameters might comprise parameters associated with performance of the five applications identified in step 201 and with performance of four server systems (identified as Server 134, Server 459, Server 789, and Server 890) that host the five applications identified in step 201.

In such an example, these performance parameters might comprise:
a number of concurrent user connections to each server port that is used by one of the five applications;
each server's % of CPU-utilization that may be attributed to each of the five applications;
each server's amount of hard-drive capacity used that may be attributed to each of the five applications; and
a number of instances of the Web site ABC.com that are instantiated on an Apache Web server application hosted on Server 459.

Further steps of the method of FIG. 2 in this example will monitor values of these and other performance parameters identified in this example in step 203.

A second set of performance parameters might comprise parameters related to usage patterns that may be directly or indirectly used to infer variations in loads on applications, services hardware, software, communications components, and other resources identified in step 201.

In this example, this second set of performance parameters might be identified by monitoring parameters that comprise the previously identified performance parameters for a specified period of time. If that specified period of time is, for example, a week, the result of this identification would be to identify how the monitored parameters fluctuated during that week.

Here, those fluctuations might reveal how the number of user connections to each monitored server port varied over the course of the week, the % of each server's CPU resources and hard-drive capacity were used throughout the week by each monitored application, and how many instances of ABC.com were provisioned during the monitored period.

In some embodiments, including the embodiment of this example, the monitoring means may flag instantaneous values of any of these parameters that cross a preset threshold. The embodiment of this example, as a function of expert knowledge of the business possessed by the system designers, and using techniques known to those skilled in the art, these preset thresholds are deemed to be the lesser of the maximum measured value and 150% of the average values of each parameter during the week of monitoring.

If, for example, the sales application on average uses 8% of Server 159's CPU capacity, but never uses more than 16%, the performance parameter associated with this utilization is flagged whenever a monitored value of this application's Server 159 CPU capacity exceeds 12%, a threshold value that is equivalent to 150% of the average monitored value, and less than the maximum monitored value.

In step 205, an impact study is performed that analyzes, organizes, and infers conclusions from the information identified in steps 201 and 203. In this example, the impact study analyzes circumstances surrounding each incident judged as “severe” in step 201. In embodiments in which multiple levels of severity may be identified, the impact study may select incidents that have been identified as being associated with severity levels that exceed a certain threshold.

The goal of the impact study is to relate a resource disruption to a resulting severe incident, to one or more social parameters, or to one or more performance parameters. Here, the impact study extrapolates the previously observed January 21^{st} incident to infer:

Incident: On January 21 of the prior year, a hardware outage of Server 134, which hosts the sales application, delayed a monthly sales report, creating a severe incident. This outage was related to the fact that Server 134 comprises outdated legacy components.

Risk: Outdated components of Server 134 may fail again.

Existing mitigation plan: The sales application has been migrated to a virtual server environment and configured on a high-availability environment.

Similarly, the impact study may extrapolate the previously observed severe incidents of March 23 to conclude:

Incident: On March 23 of the prior year, a hardware outage of Server 890, which hosts the mortgage-processing application, created a severe incident by preventing the ABC Company from processing new mortgages for four hours. This disruption was caused by loss of a network connection between the ABC Company's Bangalore and San Francisco data centers.

Risk: The network connection between the Bangalore and San Francisco data centers is unstable.

Existing mitigation plan: Create a redundant network connection between the Bangalore and San Francisco data centers. This planned solution is not yet scheduled for implementation due to funding limitations.

The impact study may further infer other conclusions from characteristics of other incidents identified in steps 201 and 203, but they are omitted here for the sake of brevity. In other embodiments, an impact study may generate other or additional types of information, as required by the embodiment, by the company, or by other goals or design criteria of implementers.

In this example, information generated in steps 201-205 may be used to further identify a frequency or period of stability that will determine a granularity of the output pulse-width modulated representation of resource criticality. In this example, such an identification might determine that the representation should show criticality on a weekly basis. This identification might be made as a function of observations that: i) the client employs a weekly maintenance schedule, resulting the collection of some times of performance data being performed at weekly intervals; and ii) historical data, including historical incident reporting, has long been made on a weekly basis.

In other examples, other types of data may be used by implementers with expert knowledge of the business's operations and goals, and using analytical methods known to those skilled in the art, to identify a different reporting period, frequency, or granularity.

In step 207 of this example, a social business index is derived for each of the applications identified in step 201 and for each reporting period under consideration.

As described above, a social business index for an application during a reporting period may be derived as a logical or numeric sum or other function of the historical impact of that application during that reporting period, of a planned risk addition or deletion related to that application during that reporting period, and of a predicted business impact related to that application during that reporting period.

In this example, we choose a formula for this derivation that may be expressed as the logical relationship:

SBI=(historic impact)+(planned risk revision)+(predicted business impact)

In this case, an SBI will assume a value of 1 (or TRUE) if any of the three terms of this equation are TRUE, and will otherwise assume a value of 0 (or FALSE). In other embodiments and examples, other functions of these terms may be used to derive social business indexes.

In this example, a social business index will be computed by means of this formula for each week of the duration of the 24-month historical study, for each of the five applications identified in step 201.

In this example, we may find that a social business index for a particular week and a particular application assumes a value of 0 when 201: i) the historical data and resulting impact study do not suggest that a previous severe incident, or a previous incident that exceeded some other threshold value of severity, will be repeated during that week (historic impact=0); ii) no planned risk revision potentially increases the likelihood of an incident having severe impact on the business during that week (planned risk revision=0); and iii) there is not predictive business expectation of an incident that will have a severe impact on the business during that week (predicted business impact=0).

On the other hand, in our example, consider week 13 for the sales application, wherein no historic impact has been identified as being associated with this particular calendar week (historic impact=0), and no planned risk revision has been identified for that week (planned risk revision=0), but an upgrade has been scheduled for the server on which the sales application runs during that week (predicted business impact=1). Because of this last factor, the social business index for the sales application during week 13 is derived as being equal to 1.

In some embodiments, if a planned risk revision had been planned for this week, wherein the planned risk addition comprised a risk deletion or mitigation, then the deletion might have canceled the predicted business impact. Such a risk deletion might, for example, comprise a rescheduling of the upgrade to another week. In such embodiments, the above formula for deriving an SBI might be revised into a numeric, rather than logical form that allows an SBI to be the result of an addition and subtraction of numeric values. In other embodiments, this relationship among the terms might be accomplished through a more nuanced logical expression.

Regardless of the exact expression of the formula for deriving an SBI, a distinct SBI is derived in step 207 for each application identified in step 201, for each week during which criticality of that application will be identified in step 213.

In step 209 of this example, a performance index value is derived for each application, service, or other resource identified in step 201 for each time period to be represented as a pulse-width modulated criticality representation in steps 211-213. These derivations may be performed manually or automatically, by means of logging, monitoring, computational, or other performance-measuring means known to those skilled in the art. Each performance index will be assigned a distinct value for each week of the criticality representation derived in step 213.

Here, a performance index of an application associated with a particular week will be assigned an integer value in the range of 1-4, where a value of 1 will be associated with the highest risk of criticality during that week and a value of 4 will be associated with the lowest risk of criticality during that week. In this example, a performance index for a week will assume a “high” value if any of the performance parameters identified in step 203 that are associated with the application assume a “high” or otherwise critical value during that week.

In this example, as described above, such performance parameters might comprise, but are not limited to:
a number of concurrent user connections made during a week to each socket of Server 134, where that socket of that server is associated with the sales application;
an amount of data written to a server port during a week, where availability of the server port is necessary to ensure acceptable performance of one of the five applications;
a portion of Server 890's CPU utilization during a week that is associated with the mortgage-processing application; and
a number of instances of ABC.com that are instantiated during a week on the Apache Web server application hosted on Server 459.

In step 211, the embodiment of this example begins its computation of pulse-width values for each application during each week of the projected report of step 213. Here, a pulse-width is determined to have a value of either 1 or 0 during a week as a function of whether it exceeds a threshold value during that week. In other embodiments, a pulse-width for a week may be deemed to have an other numeric value, a logical value of TRUE or FALSE, or some other value, such as “high” or “low.”

A value of a pulse width for a particular week and a particular application may be determined as a function of a threshold value associated with that week. Thresholds may be derivation by any sort of numeric or logical function of factors that comprise the historic impact of the application, of the social business index for the week, and of the performance index of the week.

In this example, we express a function for determining a criticality of an application during a particular week as:

criticality=(historic impact*SBI)/(performance index)

As discussed above in the description of FIG. 2 step 211, the results of these determinations may then be represented in a chart like the one shown below, which represents a week-by-week criticality of each application identified in step 201 as a pulse-width modulated waveform. Here, every week in which an application is deemed to have greater criticality is shown as a high value, a value of 1 or TRUE, or a “pulse.” Every week in which the application is deemed to have low likelihood of criticality is shown as a low value or a value of zero or FALSE. In other embodiments, multiple levels may be defined that allow identification of a greater number of degrees of criticality.

In this example, each pulse or set of contiguous pulses is associated with a pulse width, wherein the pulse width is a function of a number of adjacent or contiguous weeks in which an application is identified as being critical. This representation of criticality as a pulse-width modulated waveform allows subsequent processing of the information generated by this method to be further processed by means of pulse-width demodulation techniques known to those skilled in the art.

Additional specific examples of criticality derivations and computations are shown above in the description of step 211.

In step 213 of the current example, criticality data generated in step 211 from information identified in steps 201-209 may be used to generate a representation of the criticality data as a set of pulse-width modulated waveforms. Each waveform will identify weeks in which one of the applications identified in step 201 may become critical. Becoming critical here means that a disruption to the application during a time period deemed to be critical will have an impact on the business that is deemed to satisfy certain conditions, such as exceeding a threshold of severity.

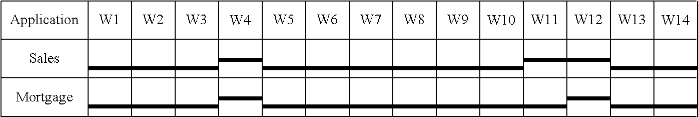

An excerpt of such a representation is shown in the above chart, which shows pulse-width modulated waveforms for two applications (the sales application and the mortgage-processing application) for the first 14 weeks of the time period under consideration.

In this representation, each column corresponds to one week of the time period under consideration. Each row corresponds to one application, service, or other resource. If a cell at the intersection of a first column and a first row is filled with a lower-value bar graph (that is, represents a zero-value pulse amplitude or pulse height), then that cell represents a finding that the application associated with the first row is not expected to become critical during the week represented by the first column.

If a cell at the intersection of a second column and a second row is filled with a higher-value bar graph (that is, represents a nonzero pulse amplitude or pulse height), such as the two cells shown here for week 4, then that cell represents a finding that the application associated with the second row is likely to become critical during the week represented by the second column.

The sample representation above, for example, shows that the sales application is likely to become a critical service during weeks 4, 11, and 12, and the mortgage-processing application is likely to become a critical service during week 4 and week 12, based on results derived during step 211 of this example as a function of impact values, social business index values, and performance index values identified in steps 201-209.

Furthermore, pulse widths may be inferred from this representation, wherein the width of a pulse may be proportional to, or otherwise a function of, the severity or duration of the criticality of an application. In other embodiments, pulse widths may be represented in other ways.

In the sample representation above, the sales application may be seen to be critical during week 4, where that criticality is represented by a pulse of width equal to 1; and may further seen to be critical during weeks 11 and 12, where that criticality is represented by a pulse of width equal to 2, as a function of the fact the pulse spans two time periods. In other embodiments, a pulse width may be represented by other means known to those skilled in the art.

What is claimed is:

1. A method for predicting criticality of a resource of a business, the method comprising:
a processor of a computer system identifying a set of resources, wherein a first resource of the set of resources may become critical to a business function during a first current time period, and wherein the first resource is considered critical during the first current time period if a disruption to the resource during the first current time period creates a severe impact upon the business function;
the processor analyzing a historical record, wherein the analyzing identifies a first severe impact upon the business function caused by a disruption of the first resource during a first historical time period, wherein the analyzing further identifies a social-parameter relationship between the first resource and a first social parameter of a set of social parameters, and wherein the analyzing further identifies a performance-parameter relationship between the first resource and a set of performance parameters;
the processor deriving a social business index value as a function of the social-parameter relationship;
the processor measuring a set of current performance values of the set of performance parameters during the first current time period;
the processor further deriving a performance index value as a function of the performance-parameter relationship and of the current performance values; and
the processor determining whether the first resource is critical during the first current time period as a criticality function of the first severe impact, of the social business index value, and of the performance index value.

2. The method of claim 1, wherein the processor chooses a criticality duration unit by further analyzing the historical record.

3. The method of claim 2, the processor represents the duration of criticality during the first current time period as a pulse of a pulse-width modulated waveform, and wherein the width of the pulse is a function of the number of criticality duration units comprised by the duration of the first current time period.

4. The method of claim 1, wherein the first social parameter is selected from a group comprising: a business schedule; a level of market demand; a level of market supply; a seasonal fluctuation in product demand or supply; and a scheduled upgrade of a business resource.

5. The method of claim 1, wherein a first performance parameter of the set of performance parameters is selected from a group comprising: a hardware or software characteristic of a hardware device; a setting of an application; a usage pattern of a service, application, or hardware device; a performance or utilization log; a response time; an attribute related to an availability of a resource; and a characteristic of a number of simultaneous or concurrent users.

6. The method of claim 1, wherein the social business index value is a function of the first historic impact and of a change in the risk that the first resource will be critical during the second time period, wherein the change in the risk is selected from a group comprising a change caused by a planned action of the business and a change predicted by a study of external factors.

7. The method of claim 1, wherein the performance index value identifies a high risk that the first resource will become critical during the first current time period if the measuring identifies that any performance parameter of the set of performance parameters exceeds a threshold value during the first current time period.

8. The method of claim 1, wherein the determining comprises determining a higher likelihood that the first resource is critical during the first current time period if the first severe impact indicates that a disruption to the first resource is more likely to have a greater impact on the business function, if the social business index indicates a greater likelihood that the first resource will be disrupted during the first current time period, and if the performance index indicates that a value of a performance parameter of the set of performance identifies a high risk that the first resource will become critical during the first current time period.

9. The method of claim 1, further comprising providing at least one support service for at least one of creating, integrating, hosting, maintaining, and deploying computer-readable program code in the computer system, wherein the computer-readable program code in combination with the computer system is configured to implement the identifying, analyzing, determining, deriving, measuring, further deriving, and determining.

10. A computer program product, comprising a computer-readable hardware storage device having a computer-readable program code stored therein, said program code configured to be executed by a processor of a computer system to implement a method for predicting criticality of a resource of a business, said method comprising:
the processor identifying a set of resources, wherein a first resource of the set of resources may become critical to a business function during a first current time period, and wherein the first resource is considered critical during the first current time period if a disruption to the resource during the first current time period creates a severe impact upon the business function;
the processor analyzing a historical record, wherein the analyzing identifies a first severe impact upon the business function caused by a disruption of the first resource during a first historical time period, wherein the analyzing further identifies a social-parameter relationship between the first resource and a first social parameter of a set of social parameters, and wherein the analyzing further identifies a performance-parameter relationship between the first resource and a set of performance parameters;
the processor deriving a social business index value as a function of the social-parameter relationship;
the processor measuring a set of current performance values of the set of performance parameters during the first current time period;
the processor further deriving a performance index value as a function of the performance-parameter relationship and of the current performance values; and
the processor determining whether the first resource is critical during the first current time period as a criticality function of the first severe impact, of the social business index value, and of the performance index value.

11. The computer program product of claim 10, wherein the processor chooses a criticality duration unit by further analyzing the historical record.

12. The computer program product of claim 11, the processor represents the duration of criticality during the first current time period as a pulse of a pulse-width modulated waveform, and wherein the width of the pulse is a function of the number of criticality duration units comprised by the duration of the first current time period.

13. The computer program product of claim 10, wherein the first social parameter is selected from a group comprising: a business schedule; a level of market demand; a level of market supply; a seasonal fluctuation in product demand or supply; and a scheduled upgrade of a business resource.

14. The computer program product of claim 10, wherein a first performance parameter of the set of performance parameters is selected from a group comprising: a hardware or software characteristic of a hardware device; a setting of an application; a usage pattern of a service, application, or hardware device; a performance or utilization log; a response time; an attribute related to an availability of a resource; and a characteristic of a number of simultaneous or concurrent users.

15. The computer program product of claim 10, wherein the social business index value is a function of the first historic impact and of a change in the risk that the first resource will be critical during the second time period, wherein the change in the risk is selected from a group comprising a change caused by a planned action of the business and a change predicted by a study of external factors.

16. The computer program product of claim 10, wherein the performance index value identifies a high risk that the first resource will become critical during the first current time period if the measuring identifies that any performance parameter of the set of performance parameters exceeds a threshold value during the first current time period.

17. The computer program product of claim 10, wherein the determining comprises determining a higher likelihood that the first resource is critical during the first current time period if the first severe impact indicates that a disruption to the first resource is more likely to have a greater impact on the business function, if the social business index indicates a greater likelihood that the first resource will be disrupted during the first current time period, and if the performance index indicates that a value of a performance parameter of the set of performance identifies a high risk that the first resource will become critical during the first current time period.

18. A computer system comprising a processor, a memory coupled to said processor, and a computer-readable hardware storage device coupled to said processor, said storage device containing program code configured to be run by said processor via the memory to implement a method for predicting criticality of a resource of a business, said method comprising:
the processor identifying a set of resources, wherein a first resource of the set of resources may become critical to a business function during a first current time period, and wherein the first resource is considered critical during the first current time period if a disruption to the resource during the first current time period creates a severe impact upon the business function;
the processor analyzing a historical record, wherein the analyzing identifies a first severe impact upon the business function caused by a disruption of the first resource during a first historical time period, wherein the analyzing further identifies a social-parameter relationship between the first resource and a first social parameter of a set of social parameters, and wherein the analyzing further identifies a performance-parameter relationship between the first resource and a set of performance parameters;
the processor deriving a social business index value as a function of the social-parameter relationship;
the processor measuring a set of current performance values of the set of performance parameters during the first current time period;
the processor further deriving a performance index value as a function of the performance-parameter relationship and of the current performance values; and
the processor determining whether the first resource is critical during the first current time period as a criticality function of the first severe impact, of the social business index value, and of the performance index value.

19. The system of claim 18, wherein the processor chooses a criticality duration unit by further analyzing the historical record.

20. The system of claim 19, the processor represents the duration of criticality during the first current time period as a pulse of a pulse-width modulated waveform, and wherein the width of the pulse is a function of the number of criticality duration units comprised by the duration of the first current time period.
